(19) United States
(12) Patent Application Publication
(10) Pub. No.: US 2008/0289836 A1
(43) Pub. Date: Nov. 27, 2008

(54) Apparatus for Preventing the Eruption of Flames from a Vehicle

(76) Inventor: Jian-Jhong Fong, Changhua City (TW)

Correspondence Address: Jian-Jhong Feng, 235 Chung - IIo, Box 8-24, Taipei, TW

(21) Appl. No.: 11/754,236

(22) Filed: May 25, 2007

(51) Int. Cl. A62C 3/07

(52) U.S. Cl. 169/62

(57) ABSTRACT

An apparatus is provided for preventing the eruption of flames from a vehicle. The apparatus includes an electronic control unit, a detector, a can and piping. The electronic control unit is provided in the vehicle. The detector is used to detect the possibility of the eruption of flames and providing the electronic control unit with a signal corresponding to the detector. The can is used to store extinguishing material for preventing the eruption of flames. The piping is used to transfer the extinguishing material from the can to at least one spot of the vehicle that is vulnerable to flames under the control of the electronic control unit.

### BACKGROUND OF INVENTION

1. Field of Invention

The present invention relates to an apparatus for preventing the eruption of flames from a vehicle, thus reducing the damage of the vehicle and the casualty of the driver and/or any passenger in the vehicle.

2. Related Prior Art

To prevent a vehicle from burning because of the overheating of the engine of the vehicle or due to a clash, a cautious driver may carry a conventional extinguisher in the vehicle. To put out fire with the conventional extinguisher, the driver has to lift the hood. When the hood is lift, fierce flames however erupt from the engine compartment since an increased amount of air enters the engine compartment. This undesired phenomenon is so called ‘chimney effect’. Moreover, the driver might be knocked out and/or trapped in the vehicle in a clash and could not operate the conventional extinguisher to put out the fire. The driver might need help. The help might come too late. The result could be tragic.

The present invention is therefore intended to obviate or at least alleviate the problems encountered in prior art.

### SUMMARY OF INVENTION

It is an objective of the present invention to provide a.

According to the present invention, an apparatus is provided for preventing the eruption of flames from a vehicle. The apparatus includes an electronic control unit, a detector, a can and piping. The electronic control unit is provided in the vehicle. The detector is used to detect risks of the eruption of flames and providing the electronic control unit with a signal corresponding to the detector. The can is used to store extinguishing material for preventing the eruption of flames. The piping is used to transfer the extinguishing material from the can to at least one spot of the vehicle that is vulnerable to flames under the control of the electronic control unit.

The primary advantage of the apparatus for preventing the eruption of flames from a vehicle is reducing the loss of the property and the casualty of the driver and/or any passenger by the automatic spreading of the extinguishing material when there is risk of the eruption of flames.

Other objectives, advantages and features of the present invention will become apparent from the following description referring to the attached drawings.

### BRIEF DESCRIPTION OF DRAWINGS

The present invention will be described via detailed illustration of embodiment referring to the drawings.

FIG. 1 is a perspective view of a vehicle equipped with an apparatus for preventing the eruption of flames from the vehicle according to the present invention.

FIG. 2 is a block diagram of an apparatus for preventing the eruption of flames from the vehicle according to a first embodiment of the present invention.

FIG. 3 is a block diagram of an apparatus for preventing the eruption of flames according to a second embodiment of the present invention.

FIG. 4 is a block diagram of an apparatus for preventing the eruption of flames according to a third embodiment of the present invention.

FIG. 5 is a block diagram of an apparatus for preventing the eruption of flames according to a fourth embodiment of the present invention.

FIG. 6 is a top view of an actuator used together with the extinguisher according to the present invention.

FIG. 7 is a top view of another actuator used together with the extinguisher according to the present invention.

### DETAILED DESCRIPTION OF EMBODIMENTS

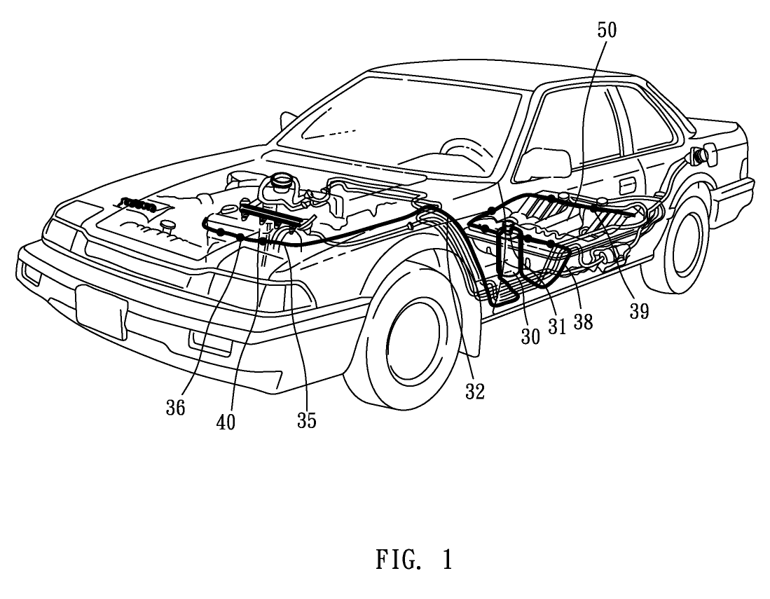

Referring to FIG. 1, a vehicle is equipped with an electronic control unit (‘ECU’) 10, an actuator 20 for initiating the expansion of airbags provided in the vehicle under the control of the ECU 10, an engine 40, a tank 50 and an extinguisher for preventing the eruption of fire from the engine 40 or tank 50 according to the present invention.

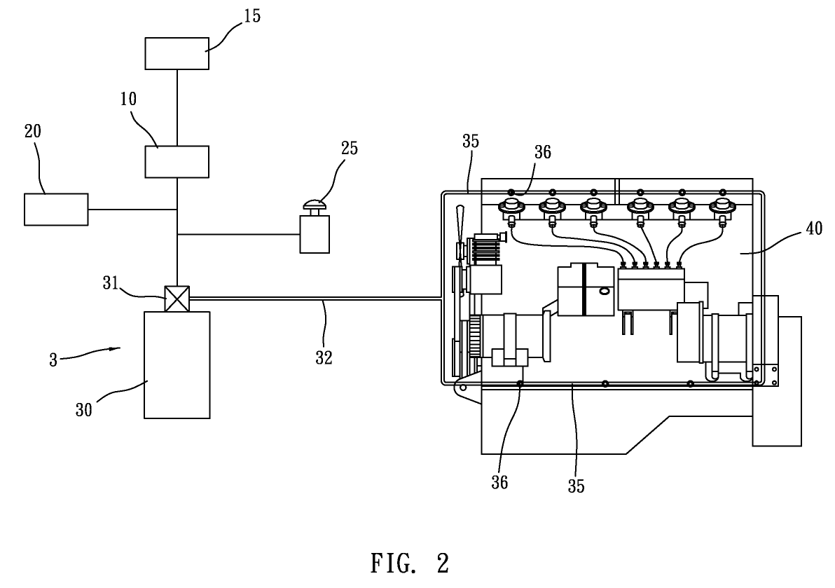

Referring to FIG. 2, there is shown an extinguisher 3 according to a first embodiment of the present invention. The ECU 10 includes at least one detector 15 for sensing impacts that the vehicle might encounter in clashes and providing the ECU 10 with signals corresponding to the impacts. After receiving the signals, the ECU 10 instructs the actuator 20 to initiate the expansion of the airbags.

The extinguisher 3 includes a can 30, a valve 31, a pipe 32, a loop 35 and nozzles 36. The can 30 stores extinguishing material such as carbon dioxide or any proper combination of extinguishing gases. The valve 31 is electrically connected to the ECU 10 so that the valve 31 closes and opens the can 30 under the control of the ECU 10. The pipe 32 is in communication with the valve 31. The loop 35 is in communication with the pipe 32. The loop 35 is arranged around the engine 40. The nozzles 36 are in communication with the loop 35 so that the nozzles 36 are located near vulnerable spots of the engine 40 where flames are most likely to occur. The vulnerable spots include the distributor, the distributor wire, the starter motor, joints for pipes and joints for parts for example. The nozzles 36 can spread the extinguishing material to choke the vulnerable spots before flames erupt from the vulnerable spots. A manual switch 25 is connected to the valve 31.

There are two possible scenarios in a clash. In the first scenario, the vehicle encounters an intensive impact. It is very likely that the driver is knocked out and/or trapped in the vehicle. The detector 15 detects the intensive impact and generates a signal corresponding to the intensive impact. On receiving the signal, the ECU 10 instructs the actuator 20 and the valve 31 to operate. The actuator 20 initiates the expansion of the airbags. On the other hand, the valve 31 opens the tanks 30 so that the extinguishing material travels to the nozzles 36 from the can 30 through the pipe 32 and the loop 35. The nozzles 36 spread the extinguishing material to choke the vulnerable spots.

In the second scenario, the vehicle encounters weak impact. It is very likely that the driver is still conscious and able to leave the vehicle. The detector 15 detects the weak impact and generates a signal according to the weak impact. On receiving the signal, the ECU 10 keeps the actuator 20 and the valve 31 idle. The actuator 20 keeps the airbags flat. On the other hand, the valve 31 keeps the tanks 30 closed. If flames should erupt from the vulnerable spots, the driver might operate the manual switch 25 to operate the valve 31. Thus, the extinguishing material travels to the nozzles 36 from the can 30 through the pipe 32 and the loop 35. The nozzles 36 spread the extinguishing material to choke the vulnerable spots.

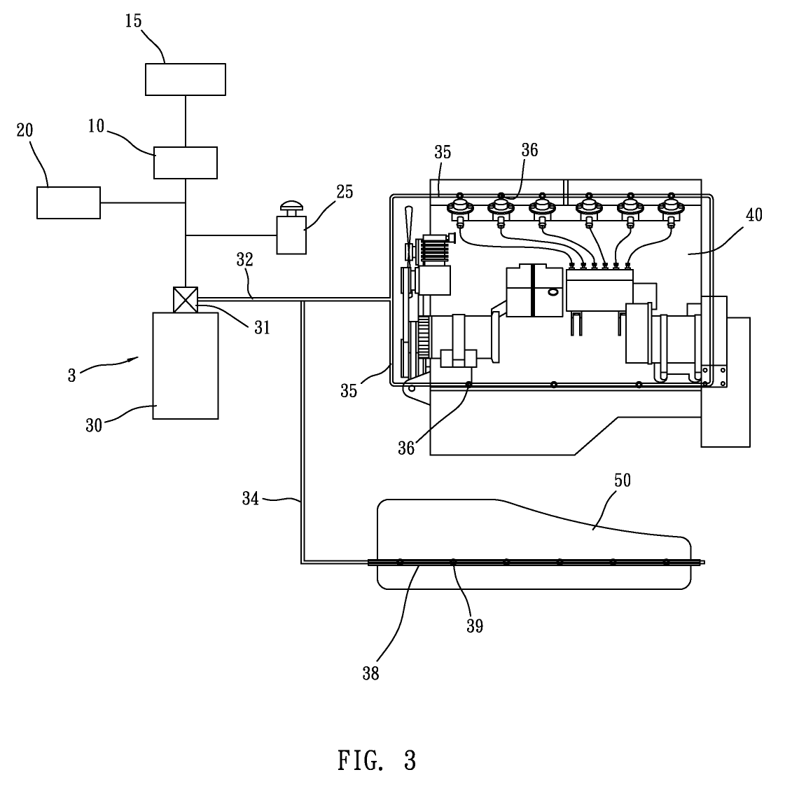

Referring to FIG. 3, there is shown an extinguisher 3 according to a second embodiment of the present invention. The second embodiment is like the first embodiment except including additionally a pipe 34, a loop 38 and nozzles 39. The pipe 34 is in communication with the pipe 32. The loop 38 is in communication with the pipe 34. The nozzles 39 are in communication with the loop 38. The loop 38 is arranged around the tank 50. Thus, the nozzles 39 can spread the extinguishing material to choke the tank 50.

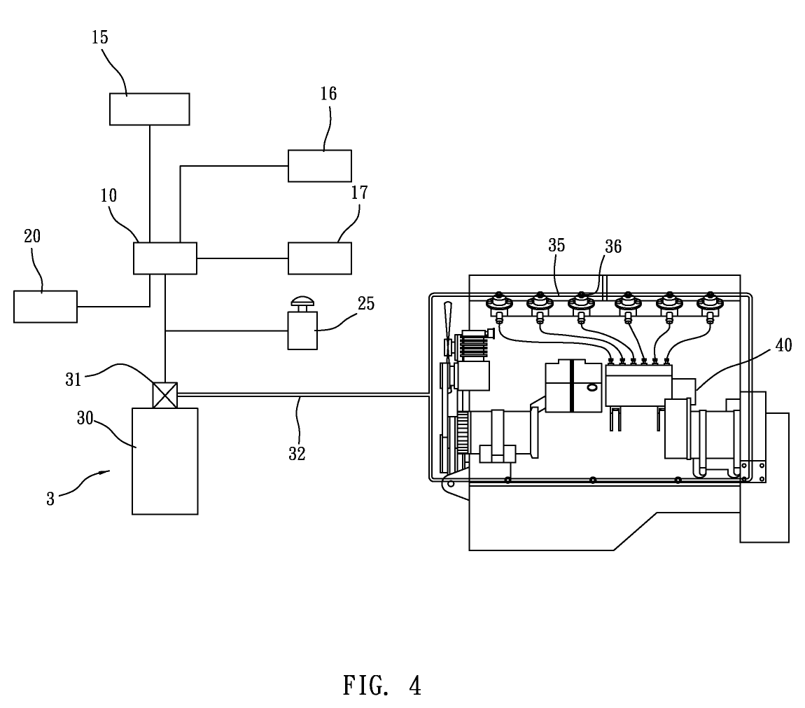

Referring to FIG. 4, there is shown an extinguisher 3 according to a third embodiment of the present invention. The third embodiment is identical to the first embodiment excepting including additionally detector 16 and 17 connected to the ECU 10. The detector 16 can detect smoke and provide the ECU 10 with a signal corresponding to the smoke. The detector 17 can detect sparks and provide the ECU 10 with a signal corresponding to the sparks. On receiving the signal from the detector 15, 16 or 17, the ECU instructs the valve 31 to operate.

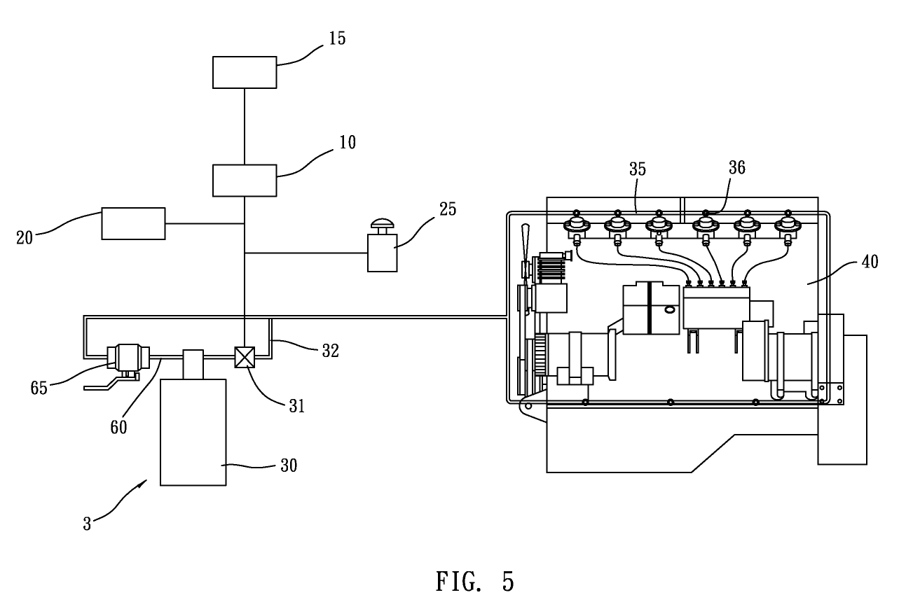

Referring to FIG. 5, there is shown an extinguisher 3 according to a fourth embodiment of the present invention. The fourth embodiment is like the first embodiment except a few things. Firstly, the pipe 32 is in communication with the can 30 at an end and in communication with the loop 35 at another end. Secondly, the valve 31 is located at a proper point of the pipe 32. Thirdly, a pipe 60 is in communication with the can 30 at an end and in communication with the loop 35 at another end. Fourthly, a valve 65 is located at a proper point of the pipe 60. Through a cable or linkage, the driver can operate the valve 65 while staying in the interior of the vehicle.

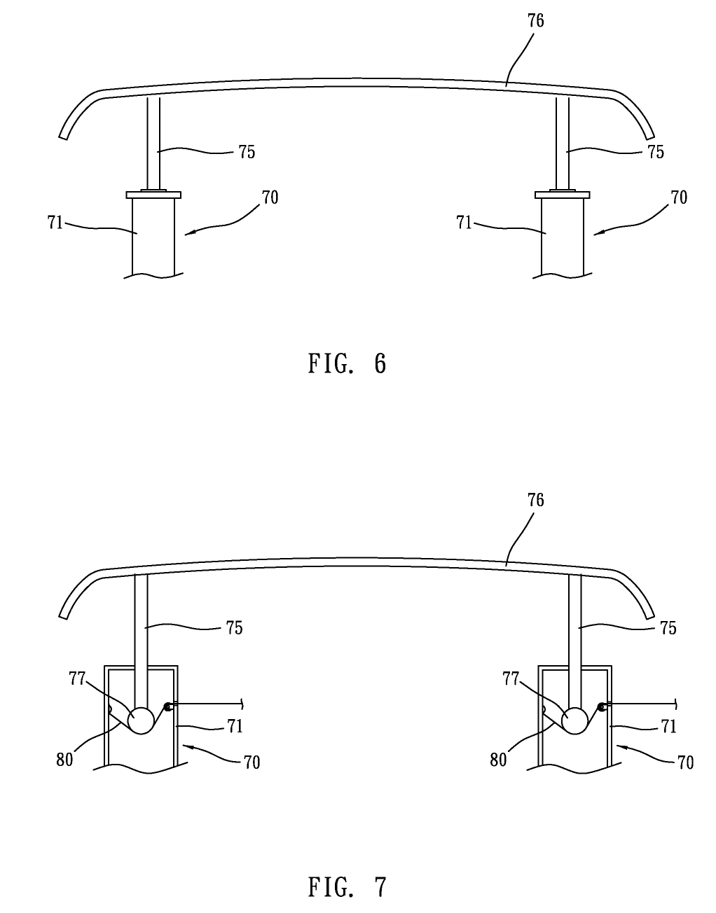

Referring to FIG. 6, there is shown an actuator 70 for actuating the valve 65. The actuator 70 includes two cylinders 71 connected to the chassis, two rods 75 connected to the cylinders 71 and a bumper 76 connected to the rods 75. The rods 75 are connected to the valve 65.

Referring to FIG. 7, there is shown another actuator 70 for actuating the valve 65. The actuator 70 includes two cylinders 71 connected to the chassis, two rods 75 connected to the cylinders 71, a bumper 76 connected to the rods 75, a pulley 77 connected to each of the rods 75 and a cable 80 connected to each of the cylinders 71 at an end and connected to the switch 30 at another end.

In a cash, the actuator 70 shown in FIG. 6 or 7 causes the valve 65 to open the can 30 without the operation of the valve 31 under the control of the ECU 10 in cooperation with the detector 15, 16 or 17.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. An apparatus for preventing the eruption of flames from a vehicle, the apparatus comprising:
an electronic control unit provided in the vehicle;
at least one detector for detecting risks of the eruption of flames and providing the electronic control unit with a signal corresponding to the detector;
a can for storing extinguishing material for preventing the eruption of flames; and
piping for transferring the extinguishing material from the can to at least one spot of the vehicle that is vulnerable to flames under the control of the electronic control; and
wherein the piping comprises a valve mechanically operable for opening and closing the can;
an actuator mechanically operable to control the valve; and the actuator includes a bumper connected to the chassis of the vehicle on one hand and connected to the valve on the other hand: the actuator comprises at least one rod connected to the bumper on one hand and connected to the valve on the other hand: the actuator further comprises at least one cylinder for receiving an end of the rod;
a pulley connected to the end of the rod; and
a cable wound around the pulley and formed with an end connected to the cylinder and another end connected to the valve.

2. The apparatus according to claim 1 wherein the piping comprises a valve for closing and opening the can under the control of the electronic control unit.

3. The apparatus according to claim 2 wherein the piping comprises a pipe in communication with the valve and a loop in communication with the pipe and arranged around the spot of the vehicle.

4. The apparatus according to claim 3 wherein the piping comprises at least one nozzle in communication with the loop.

5. The apparatus according to claim 2 comprising a manual switch operable to control the valve.

6. The apparatus according to claim 1 wherein the at least one detector is used to detect an impact and provide the electronic control unit with a signal corresponding to the impact.

7. The apparatus according to claim 1 wherein the at least one detector is used to detect smoke and provide the electronic control unit with a signal corresponding to the smoke.

8. The apparatus according to claim 1 wherein the at least one detector is used to detect a spark and provide the electronic control unit with a signal corresponding to the spark..

9-14. (canceled)
